(19) United States
(12) Patent Application Publication
(10) Pub. No.: US 2026/0210799 A1
(43) Pub. Date: Jul. 23, 2026

(54) METHOD FOR ALIGNING OPTICAL COMPONENTS IN QUANTUM ELECTROMAGNETIC AND NONLINEAR OPTICAL SYSTEMS THAT EMPLOY SPONTANEOUS PARAMETRIC DOWNCONVERSION TO GENERATE PHOTON ENTANGLEMENT

(71) Applicant: Colin B. Quinn, Novi, MI (US)

(72) Inventor: Colin B. Quinn, Novi, MI (US)

(21) Appl. No.: 19/029,262

(22) Filed: Jan. 17, 2025

(51) Int. Cl. G01M 11/02

(52) U.S. Cl. CPC G01M 11/02

(57) ABSTRACT

A method for aligning an optical component along a spontaneous parametric down conversion (SPDC) cone generated by a nonlinear crystal involves directing photons through the crystal, estimating the quantities of entering and exiting photons at specific frequencies, and strategically placing a single photon detector to intercept the exiting photons. The method includes estimating and measuring photon counts within the detector's active area, adjusting the detector's position for alignment, and placing the optical component at the preferred location based on detailed approximations of photon distribution and detector efficiency.

### TECHNICAL FIELD

This invention relates to a method for aligning optical components in quantum electromagnetic and nonlinear optical systems that employ spontaneous parametric downconversion to generate photon entanglement.

### BACKGROUND

The present invention relates generally to the field of nonlinear optics and more specifically to methods and apparatuses for generating entangled photon pairs via spontaneous parametric down conversion (SPDC) in nonlinear optical crystals.

SPDC is a nonlinear optical process that occurs when a pump photon interacts with a nonlinear optical crystal and is converted into a pair of daughter photons, known as signal and idler photons. This process is governed by the conservation of energy and momentum, where the sum of the energies and momenta of the signal and idler photons must equal the energy and momentum of the pump photon.

The generation of entangled photon pairs via SPDC has found numerous applications in various fields, including quantum optics, quantum computing, quantum cryptography, and quantum metrology. Entangled photon pairs exhibit quantum correlations that cannot be explained by classical physics, making them valuable resources for fundamental studies of quantum mechanics and enabling novel technologies based on quantum principles.

In a typical SPDC setup, a high-intensity pump laser beam is focused into a nonlinear optical crystal, such as beta-barium borate (BBO) or potassium titanyl phosphate (KTP). The phase-matching condition, which ensures efficient energy transfer between the pump and generated photons, can be achieved through different types of phase-matching in the nonlinear crystal, resulting in characteristic SPDC cone(s) representing the spatial distribution of the entangled photon pairs.

One significant challenge in working with SPDC is the vast difference in intensity between the pump laser and the down-converted signal and idler photons. The pump laser typically has a much higher intensity, which can overpower the relatively weak SPDC output. Precise alignment of optical components, such as filters and apertures, is crucial to isolate and manipulate the entangled photon pairs effectively.

Aligning and optimizing the optical components in an SPDC setup can be a complex and time-consuming process, requiring careful consideration of factors such as beam paths, polarization states, and collection efficiencies. Even minor misalignments or imperfections in the optical components can significantly degrade the performance of the SPDC source, leading to reduced generation rates, decreased entanglement quality, or increased noise levels.

The costs associated with SPDC setups can be substantial, including high-quality nonlinear optical crystals, powerful pump lasers, precision optical mounts and stages, and specialized detectors capable of resolving single photons. Additionally, environmental factors like temperature fluctuations and mechanical vibrations can adversely affect the stability and performance of SPDC sources, potentially requiring additional measures for isolation and stabilization, further increasing the overall complexity and cost.

Despite these challenges, the remarkable potential of entangled photon pairs generated via SPDC continues to drive research efforts aimed at developing more efficient, robust, and cost-effective SPDC sources. Ongoing research efforts also focus on exploring new nonlinear optical materials, optimizing phase-matching conditions, and investigating novel applications of entangled photons in various domains of science and technology.

### SUMMARY

The present invention pertains to a precise method for aligning an optical component along a spontaneous parametric down conversion (SPDC) cone generated by a nonlinear crystal. This method involves directing photons from an optical energy source through the nonlinear crystal and estimating the quantity of photons with a first frequency (ω) entering the crystal over a specific time unit. Subsequently, the number of photons exiting the crystal along the SPDC cone with a second frequency (ω/2) is approximated.

A single photon detector is strategically placed to intercept the exiting photons with the second frequency (ω/2). The method includes estimating the expected number of photons within the detector's active area over a designated period (t1) and measuring the actual quantity detected. If there is a discrepancy between the actual and expected photon counts, the detector is incrementally moved until alignment is achieved. The preferred location for the optical component is then defined and the component is placed accordingly, thus completing the alignment of the optical component.

The method provides a detailed approach for estimating the expected photon count, including approximations based on the SPDC cone's circumference and the quantum efficiency of the single photon detector. This ensures accurate and efficient alignment of the optical component.

The above features and advantages and other features and advantages of the present invention are readily apparent from the following detailed description of the best mode for carrying out the disclosure when taken in connection with the accompanying drawings.

### BRIEF DESCRIPTION OF THE DRAWINGS

FIG. 1a depicts a flowchart that provides steps for one embodiment of the present invention

FIG. 1b shows the optical setup in one embodiment of the present invention.

FIG. 2 shows the typical SPDC process, where a pump laser enters an nonlinear crystal and is converted into a cone of SPDC photons.

FIG. 3 depicts the beam path of the laser and the SPDC photon cone.

FIG. 4 depicts the tolerance range of the SPDC cone represented as a projection.

FIG. 5 shows where the APD single photon detector should be placed in relation to the projection of the SPDC cone circumference.

FIG. 6 shows how the curvature of the SPDC cone circumference is approximated as a straight line.

FIG. 7 depicts the right triangle representation of the beam path of the SPDC photons, used for computational purposes only.

FIG. 8 shows how the SPDC cone's interactions with the active area should be estimated depending on which slice of the cone they occur in.

FIG. 9 shows the starting point of the APD single photon detector and the direction to incrementally move it.

### DESCRIPTION

When a laser of a particular wavelength passes through a type 1 nonlinear crystal that is tuned for that wavelength, a cone of down converted photons with approximately half of the original frequency is produced. This can be useful for many applications because the produced photons emerge entangled in pairs (i.e. a “signal” photon and an “idler” photon emerge entangled), and pairs of entangled photons are useful in a range of scientific and engineering applications.

SPDC, however, is not an easy thing to use in experimentation or any other optical setup. In the experimentation related to this invention, the nonlinear crystal that was used generated about one photon per one hundred billion pump photons, and the entangled photons that were produced were outside the frequency range of human sight. Having such a low comparative intensity and being invisible to the naked eye leads to an extremely lengthy alignment process and a setup that is extremely prone to noise.

The present invention is meant to be used to estimate detection intensities so instruments can be used to locate the SPDC cone with a higher confidence, noise can be properly benchmarked, and the alignment process can be sped up dramatically.

In SPDC, a photon pump (a laser) with a particular frequency is shined through a nonlinear crystal. As the laser passes through the nonlinear crystal, a very small portion of the photons will be split in two, according to the law of conservation of momentum, and emerge entangled. Each of these entangled photons will have a frequency of half of the original laser frequency. As the produced entangled photons emerge from the crystal, each one's path of travel will deviate at a particular angle from the original laser beam. The two entangled photons will deviate from the beam at the same angle but on opposite sides of the beam. As this happens repeatedly with many other photons, the characteristic “SPDC cone” is created.

Because of the difficulty of finding this cone on an optical experimentation lab table, there are many common practices that are used to aid in the process, but all of them have flaws.

One common practice is to remove as much light pollution from the room as possible, but this is easier said than done. Boxes can be built to enclose an optical setup, but these are often not completely sealed from outside light, and reflections from the pump laser or light produced by equipment can cause noise. There are also typically many sources of light in labs even after the lights are turned off, including computers, exit signs, and unblocked light seeping in from windows or around doors. Light filters can also be added to photon detectors, but these are typically expensive and have an imperfect frequency range to detect whatever photons are being searched for.

Another common practice is to use secondary lasers in the visible frequency range at the expected SPDC cone angle to roughly align the optical components, but it's extremely unlikely that any secondary laser could truly be aligned with an expected SPDC cone angle because the error compounds with more optical components and because Snell's law dictates that light of a different frequency will interact differently with a refractive surface.

Typically, single photon counters are used to detect SPDC cones. With filters added and sources of noise removed or blocked, single photon counters will be used to probe an area to find an expected location of an SPDC cone. Because noise can vary so dramatically, this can be an arduous and frequently inconclusive process. The present invention is to be used to take the guesswork out of this probing.

Most basically, the crux of the present invention is a process to estimate an expected number that will appear on the single photon counter when the SPDC cone has been properly located. The estimation generates an approximate number of SPDC photons, which can be used to better differentiate noise photons from SPDC photons. Generally, Claim 1 lays out how the SPDC estimation is used, and Claim 2 lays out how the SPDC estimation is created.

To use the SPDC estimation, a typical SPDC setup is first created with at least a laser, a nonlinear SPDC crystal, and a single photon detector. The noise level in the setup can be estimated when the setup is on and running, but the single photon detector is not in the expected beam path of the SPDC cone. Crucially, the noise level detected by the single photon detector must be at a level where the estimated SPDC count would be distinguishable from the baseline noise level. (For example, if the noise level fluctuates around 1000 photons per unit of time and the expected value of SPDC photons is about 100 photons per unit time, it could be difficult to distinguish between the SPDC photons and noise. If the noise is reduced to about 100 noise photons per unit time, it would be much easier to see the spike in values when the single photon detector passes over the SPDC cone. It would be even better if the number of noise photons was reduced to about 10 noise photons per unit time, because the jump from baseline noise photons alone to baseline noise photons plus SPDC photons would be very clear). Currently, it is not common practice to use an expected SPDC photon value to generate a signal to noise ratio, which this invention uses to generate data confidence and improved efficiency when locating an SPDC cone.

To create an SPDC estimation, data needs to be collected and calculations need to be performed with certain estimations.

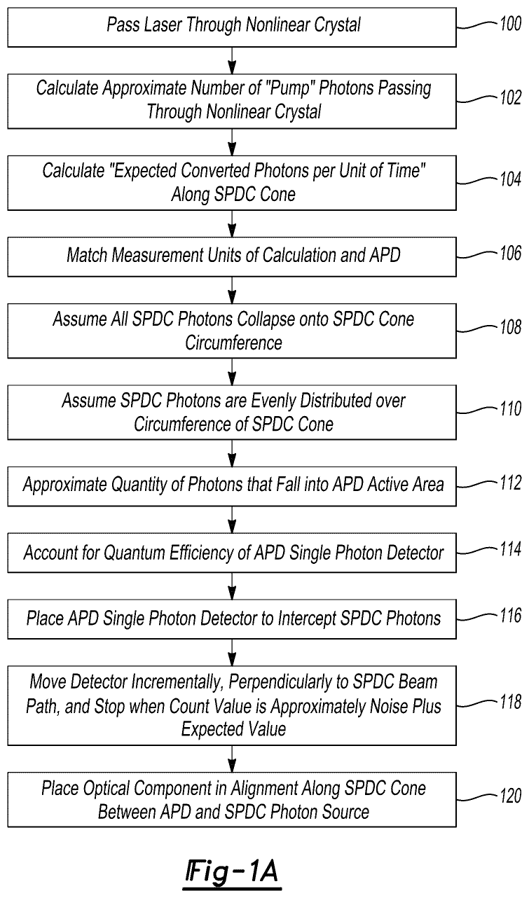

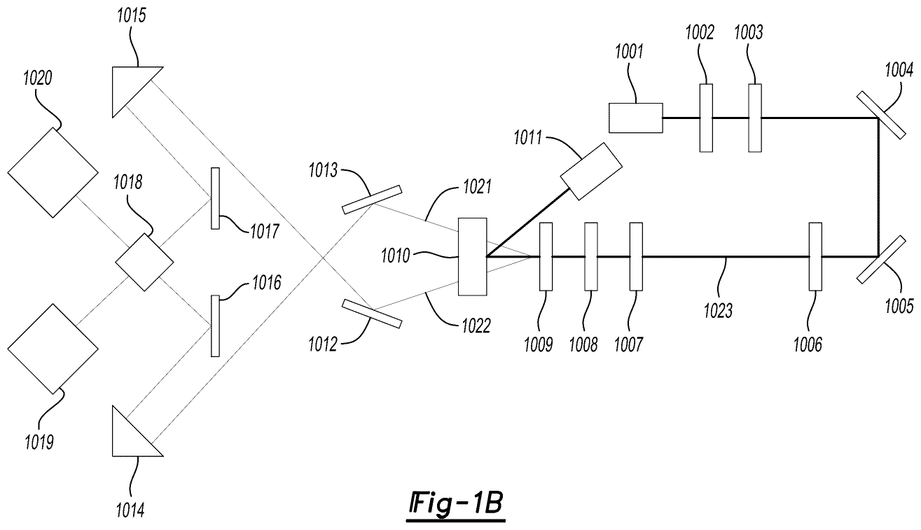

Referring to FIG. 1b, The diagram represents the experiment. The parts listed include the following
1001) 402 nm 140 mW Blue OBIS 405 Laser
1002) meter focal length lens, focusing on the BBO SPDC Crystal
1003) 400 nm cleanup filter
1004) E02 Adjustable mirror
1005) E02 Adjustable mirror
1006) Aperture with a small enough opening to only let through the laser beam and block scattering
1007) Linear Polarizer (LP) specified for 405 nm light
1008) Half Wave Plate (HWP) specified for 405 nm light in mount that can be rotated about the laser axis
1009) Beta Barium Borate (BBO) type 1 crystal with 3 degree SPDC cone in mount that can be rotated about the laser axis
1010) 810 nm long pass filter to pass SPDC photons and reflect 402 nm blue laser
1011) Beam blocker to catch 402 nm blue laser
1012) EO3 mirror
1013) EO3 mirror
1014) E03 Right angle prism on a mount that can move back and forth to create delay in the interferometer
1015) E03 Right angle prism
1016) EO3 mirror
1017) E03 mirror
1018) Polarizing beam splitter, where HOM interference takes place
1019) APD Single Photon Counter
1020) APD Single Photon Counter
1021) 804 nm SPDC cone, A side
1022) 804 nm SPDC cone, B side
1023) 402 nm blue laser

The embodiment above diagrams an experiment using the present

invention to be set up. Component 1001 is the laser “pump” that generates the laser. Component 1002 is a lens that focuses the laser light on the BBO Crystal (i.e. Component 1009). Component 1003 is a filter used to “clean up” the laser, removing any extraneous wavelengths outside of the desired spectrum. Components 1004 and 1005 are mirrors used to redirect the laser light. Component 1006 is an aperture that is closed to a size slightly larger than the laser beam cross section in order to prevent scattered light from interfering with the experiment. Components 1007 and 1008 are a linear polarizer and half wave plate respectively, used to prepare the laser to properly interact with the BBO Crystal (i.e. Component 1009). Component 1009 is the Beta Barium Borate (BBO) type 1 crystal that produces a 3 degree Spontaneous Parametric Down Conversion (SPDC) cone in a mount that can be rotated about the laser axis. This means that the photons of the SPDC cone exit the BBO Crystal at a 3 degree angle (θ) from the laser path (FIG. 3). Component 1010 is a 810 nm long pass filter used to pass SPDC photons through the filter and reflect the 402 nm blue laser. Component 1011 is a beam blocker that captures the reflected 402 nm blue laser to prevent scattering. Components 1012 and 1013 are both E03 mirrors used to change the beam path of the opposing sides of the SPDC cone. Components 1014 and 1015 are E03 Right angle prism reflectors, where 1015 is fixed and 1014 is on a movable mount to change the beam path length and, in effect, create an interferometer. Components 1016 and 1017 are both E03 mirrors. Component 1018 is a polarizing beam splitter, where the two beams interact. In this experiment, this is where Hong-Ou-Mandel (HOM) interference was meant to take place. The components represented by 1019 and 1020 are Avalanche Photodiode (APD) single photon counters with 810 nm band pass filters mounted over the detection area.

In this particular embodiment, the laser setup was being used to detect HOM interference between single photons. The most difficult part in running these experiments tends to be the alignment of the optical components. In this instance, the 810 nm light produced by the BBO crystal is considered near-infrared and therefore almost outside the spectrum of light visible to humans. Additionally, the BBO crystal has a conversion efficiency of about one in one hundred billion, so these photons are significantly more difficult to detect and align.

The present invention is used to estimate the expected value of the number of photons during a defined period of time to be detected by the single photon detector, and to use the information to align the optical system.

As it relates to the present invention and as depicted in FIG. 1a, the first step, step 100, is to set up the optical system as described above and in FIG. 1b, and align the laser such that it passes through the nonlinear crystal.

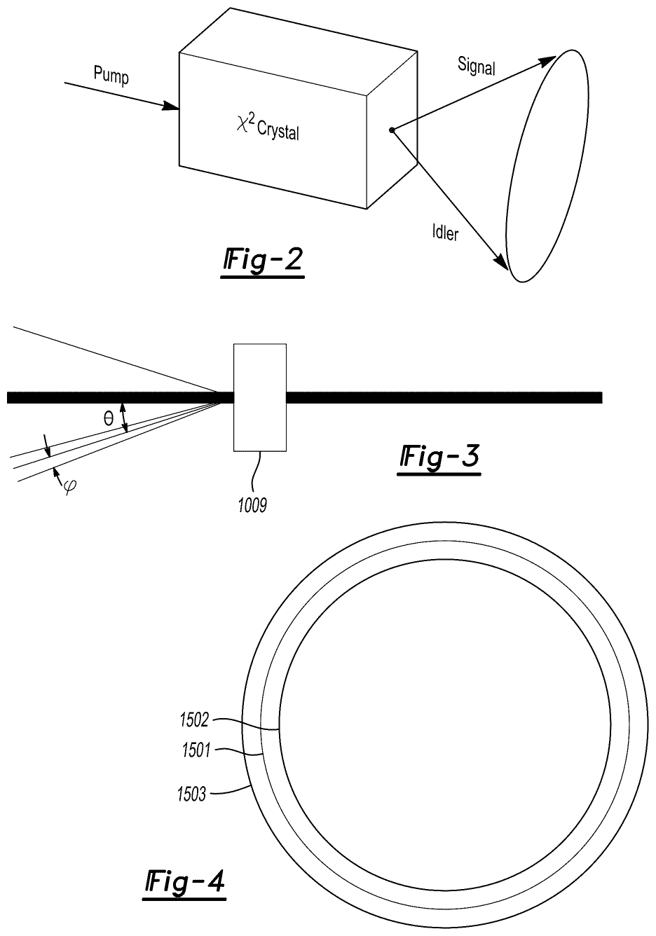

The next step at step 102, is to calculate an approximate number of “pump” photons passing through the nonlinear crystal, as seen in FIG. 2. This can be calculated by dividing the power rating of the pump laser by the frequency of the laser, then dividing that by Planck's constant, and will produce a value with units “expected pump photons per unit of time”.

Referring to FIG. 2, each photon in the SPDC cone is in a state of quantum entanglement with a photon on the opposing side of the SPDC cone. Each entangled pair consists of a “signal” and an “idler” photon.

Next, at step 104, an approximate number of SPDC photons exiting the nonlinear crystal along the cone angle (θ of FIG. 3) is calculated by multiplying the BBO conversion efficiency by the value of “expected pump photons per unit of time” to get a value of “expected converted photons per unit of time”.

Referring to FIG. 3, The BBO Crystal specifies that the angle of the SPDC cone (θ) has a defined tolerance (φ). In the present invention, it is approximated that φ=0 and all of the SPDC photons lie on the angle θ. Item 1009 is the BBO crystal, as depicted in FIG. 1b. The laser is represented by the thick black line, angle θ is represented by the thin black line, and the tolerance, φ, is represented by the thin gray range. The assumption is that all of the photons that lie in the gray range collapse onto the black line.

Next, at step 106, the time basis of the “expected converted photons per unit of time” should be converted to the time basis (i.e. measurement time) for the APD single photon counter. In this case, the APD single photon counter's measurement time is 0.2 seconds, so the “expected converted photons per unit of time” (where the unit of time is in seconds in this case) should be divided by five to convert to “expected converted photons per measurement time” (where the measurement time is 0.2 seconds in this case).

Next, the number of photons expected in the active area of the APD single photon detector per unit of time needs to be estimated. The active area is the area where photons can be detected on the APD single photon detector.

To do this, first the approximation is made at step 108 that all SPDC photons produced by the BBO crystal fall exactly on the angle of the cone, prescribed by the BBO crystal's specification sheet, without any range of tolerance. This is displayed in FIG. 4, where the SPDC photons would fall anywhere between circle 1502, the minimum tolerance limit, and 1503, the maximum tolerance limit. For the present invention, it is assumed that all SPDC photons collapse onto the circumference of circle 1501.

Referring to FIG. 4, Item 1501 represents the assumed circumference of the SPDC cone. It is assumed that all SPDC photons between 1502 and 1503 collapse onto. Item 1502 represents the inner edge of SPDC cone margin of error, φ. Item 1503 represents the outer edge of SPDC cone margin of error, φ.

Then, at step 110, a separate assumption is also made that the SPDC photons that are generated are evenly distributed over the circumference of the SPDC cone (θ) and a value of “expected converted photons per unit of time per unit of length” can be generated by dividing the “expected converted photons per unit of time” by the circumference of the SPDC cone at the detection distance.

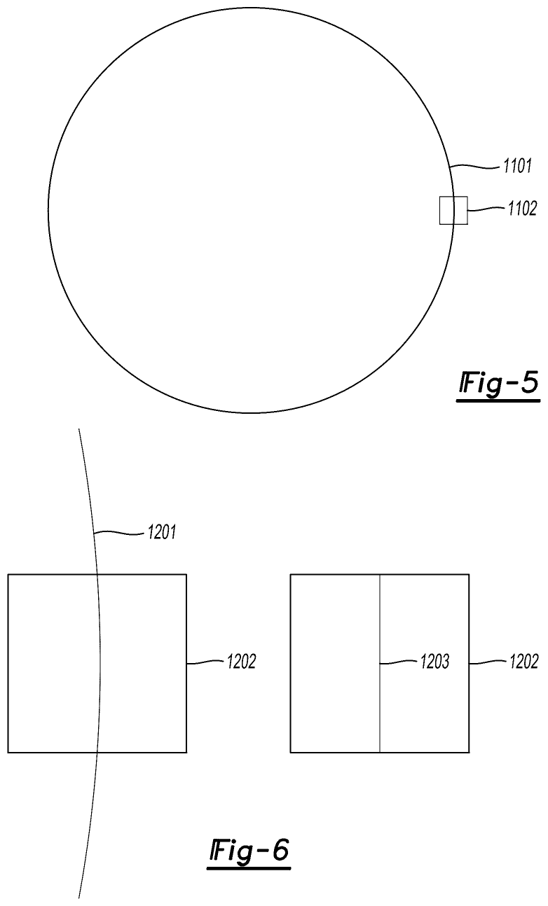

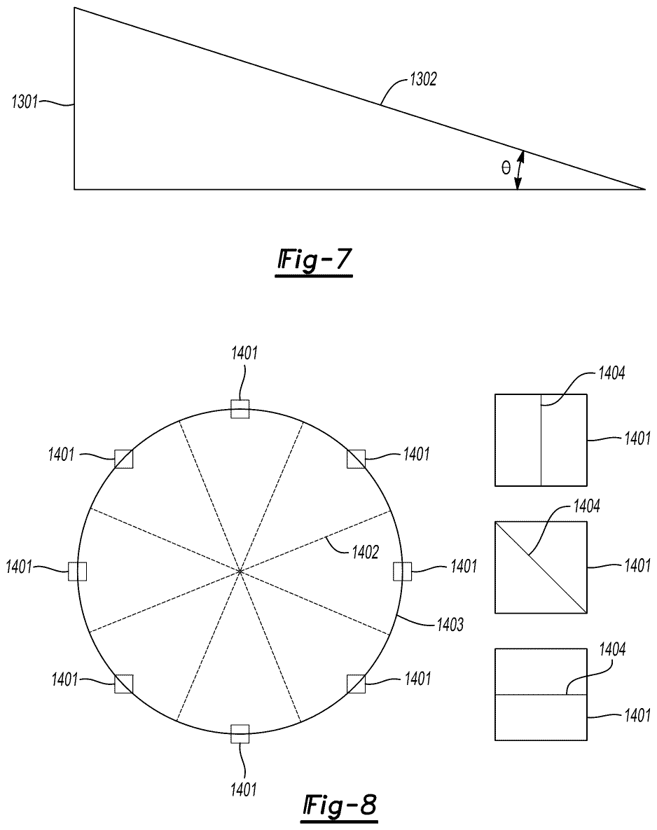

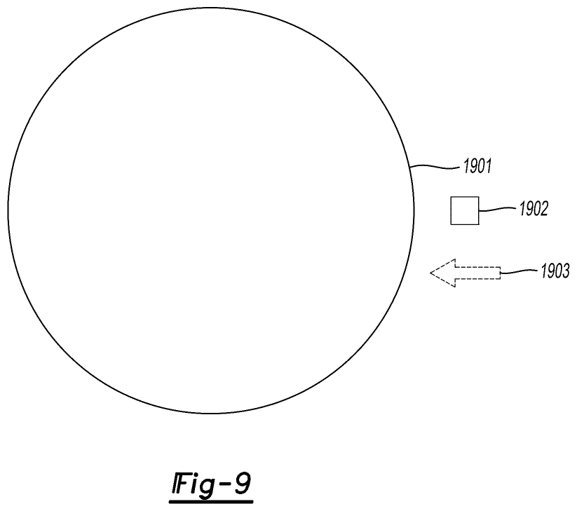

Then, at step 112, another assumption is made that the number of photons per unit of time that fall in the active area of the APD single photon detector is approximately equal to the “expected converted photons per unit of time per unit of length” multiplied by the vertical height of the active area. This value will be referred to as “expected number of interactions with the active area of the single photon detector per unit of time”. This can be understood by assuming that the circumference of a large circle (i.e. the circle projected on the active area by the SPDC cone in FIG. 5, where 1101 represents the SPDC cone circumference and 1102 represents the APD active area) when overlapping a small rectangle will cross the rectangle in a manner that can be approximated as a straight line, as in FIG. 6, where 1202 represents the APD active area, 1201 represents a section of the SPDC cone circumference, and 1203 represents the straight line approximation of the SPDC circumference. Depending on the location of the APD, the vertical height can be replaced by the diagonal length or the horizontal width, according to FIG. 8.

Referring to FIG. 5, Item 1101 represents the assumed circumference of SPDC cone. Item 1102 represents the active area of APD single photon detector.

Referring to FIG. 6, Item 1201 represents the SPDC cone circumference projected onto the active area of the APD (1202). Item 1202 represents the APD single photon detector active area. Item 1203 represents the straight line approximation of SPDC cone circumference

Referring to FIG. 8, the SPDC cone's interactions with the active area should be estimated differently depending on which slice of the cone they occur in. If in the left or right slice, they should be calculated in a way that is consistent with the top APD diagram. If in the top or bottom slice, they should be calculated in a way that is consistent with the bottom APD diagram. If they occur in any other slice, they should be calculated in a way that is consistent with the middle APD diagram. Item 1401 represents the APD active area. Item 1402 represents division lines, for representation only. Item 1403 represents the SPDC cone circumference. Item 1404 represents an estimation of SPDC intersection with APD.

Next, at step 114, the “expected number of interactions with the active area of the single photon detector per unit of time” is multiplied by the quantum efficiency of the APD single photon detector to determine the “expected number of photons to be detected within the active area per unit of time”

This calculation is used at step 116, where the APD single photon detector is placed near the approximate location of the SPDC cone (but not at the approximate location) to intercept the SPDC photons. The user should take note of the noise photons that the APD single photon detector is detecting and ensure that the calculated “expected number of photons to be detected within the active area per unit of time” will be distinguishable from the baseline noise level. For example, the baseline noise level should be no more than the calculated “expected number of photons to be detected within the active area per unit of time.” To reduce the baseline noise, it is recommended to block extraneous light sources and add targeted light filters to the APD.

Next, at step 118, the detector should be incrementally moved perpendicularly to the path of travel of the SPDC photons, as seen in FIG. 9. When the detected level of photons jumps to a value that is substantially equal to the baseline noise plus the “expected number of photons to be detected within the active area per unit of time,” the APD single photon detector's active area is in the path of the SPDC cone.

Referring to FIG. 9, Item 1901 represents the SPDC circumference. Item 1902 represents the APD single photon detector active area. Item 1903 shows the direction to move the APD single photon detector when performing the alignment.

Finally, at step 120, any optical component that needs to be aligned in the system should be placed somewhere along the path between the active area of the APD single photon detector and the SPDC crystal (or any other component that acts as the SPDC photon source in that segment of the optical system.

In some embodiments of the invention, these steps may be performed in a different order. Any different order will suffice as long as the necessary prerequisite optical setups or derivations are completed. For example, step 104 requires that step 102 is completed, and step 106 requires that step 104 is completed.

The above process shows the steps to align a first component down the beam path following the BBO crystal, but other components can be added following the first component making the following minor changes. The value of the circumference needs to change for any component down the beam path. The new circumference can be determined by summing the distances between the BBO crystal and the first component, then the first and second components, then the second and third components, and so on. Referring to FIG. 7, that summed value becomes the hypotenuse of a right triangle, 1302, where the angle θ is the angle prescribed by the BBO Crystal specification and the opposite side is the radius of the SPDC cone, 1301. That radius can then be used to calculate the circumference of the SPDC cone projection.

Referring to FIG. 7, item 1301 represents the radius of SPDC cone. Item 1302 shows the hypotenuse of SPDC cone and the sum distances between BBO & optical components. This is the path of travel of the SPDC photons.

The present embodiment of the invention assumes that the APD single photon detector will fall in the far left and far right sixths of the SPDC cone circle, but the chord approximation can be made according to any of the eighths of the circle, as shown in FIG. 8, where 1401 represents the APD superimposed onto the SPDC cone circumference, 1402 represents divisions of the SPDC cone circumference, 1403 represents the SPDC cone circumference, and 1404 represents the straight line approximations in various configurations.

Exemplary embodiments of the present disclosure have been presented. The disclosure is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the disclosure.

What is claimed is:

1. A method of aligning an optical component along a spontaneous parametric down conversion (SPDC) cone generated by a nonlinear crystal, the method comprising:
a. Directing a ray of photons from an optical energy source though a nonlinear crystal;
b. Determining an estimate of a quantity of the photons with a first frequency (ω) entering the nonlinear crystal over a unit of time produced by the optical energy source;
c. Approximating a number of the photons exiting the nonlinear crystal along the cone with a second frequency (ω/2) converted via spontaneous parametric down conversion by the nonlinear crystal over a unit of time;
d. Placing a single photon detector at an estimated location to intercept the exiting photons having the second frequency (ω/2);
e. Estimating an expected number of photons to be detected within an active area of the single photon detector during a period of time (t1);
f. Measuring an actual quantity of photons detected within the active area during the period of time (t1);
g. If the actual quantity of detected photons is not substantially equal to the expected number of photons, then incrementally moving the single photon detector until the single photon detector detects approximately the expected number of photons within the active area plus the baseline noise level, thereby defining a preferred location for the optical component, and then
h. Placing the optical component at that preferred location to receive the photons having the second frequency (ω/2).

2. The method of claim 1, wherein the estimating of the expected number of photons to be detected within the active area comprises:
a. Approximating that the field of ω/2 photons surrounding the SPDC cone's circumference is found on the SPDC cone's circumference;
b. Assuming the number of the photons exiting the nonlinear crystal along the cone with a second frequency (ω/2) converted via spontaneous parametric down conversion by the nonlinear crystal over a unit of time are evenly distributed over the SPDC cone's circumference to generate a rate of ω/2 photons per unit length;
c. Approximating a proportion of the SPDC cone circumference that will intersect with the active area of the single photon detector as a geometric chord having the same rate of ω/2 photons per unit length as the SPDC circumference and the same length as the length or width of the active area of the single photon detector; and
d. Multiplying the rate of ω/2 photons per unit length by the length of the geometric chord to produce an expected number of interactions with the active area of the single photon detector per unit of time;
e. Multiplying the expected number of interactions with the active area of the single photon detector per unit of time with a quantum efficiency of the single photon detector to produce the expected number of photons to be detected within the active area per unit of time.

3. The method of claim 1, wherein the estimating of the expected number of photons to be detected within the active area comprises:
a. Approximating that the field of ω/2 photons surrounding the SPDC cone's circumference can be found on the SPDC cone's circumference;
b. Assuming the number of the photons exiting the nonlinear crystal along the cone with a second frequency (ω/2) converted via spontaneous parametric down conversion by the nonlinear crystal over a unit of time are evenly distributed over the SPDC cone's circumference to generate a rate of ω/2 photons per unit length;
c. Approximating a proportion of the SPDC cone circumference that will intersect with the active area of the single photon detector as a geometric arc having the same rate of ω/2 photons per unit length as the SPDC circumference and the same linear length as the length or width of the active area of the single photon detector;
d. Multiplying the rate of ω/2 photons per unit length by the length of the geometric arc to produce an expected number of interactions with the active area of the single photon detector per unit of time;
e. Multiplying the expected number of interactions with the active area of the single photon detector per unit of time with a quantum efficiency of the single photon detector to produce the expected number of photons to be detected within the active area per unit of time.

4. The method of claim 1, wherein determining the circumference of the SPDC cone at different points in an optical system comprises:
a. Summing the distances between the nonlinear crystal and subsequent optical components to obtain a total path length;
b. Using the total path length as a hypotenuse of a right triangle where one angle is defined by the SPDC cone angle (θ) specified by the nonlinear crystal;
c. Calculating the radius of the SPDC cone at that point using the right triangle; and
d. Computing the circumference of the SPDC cone using the calculated radius.

5. The method of claim 1, wherein placing the single photon detector comprises:
a. Initially positioning the detector near but not at the estimated location of the SPDC cone;
b. Measuring a baseline noise level of photon detection when the detector is not in the SPDC cone path;
c. Verifying that the expected number of SPDC photons are distinguishable from the baseline noise level; and
d. If the expected number of SPDC photons would not be distinguishable, implementing additional noise reduction measures before proceeding with alignment.

6. The method of claim 5, wherein the noise reduction measures comprise at least one of:
a. Adding targeted light filters to the single photon detector;
b. Blocking extraneous light sources;
c. Installing light-blocking enclosures; or
d. Reducing ambient light.

7. The method of claim 1, wherein incrementally moving the single photon detector comprises:
a. Moving the detector in a direction perpendicular to a path of travel of the photons;
b. Monitoring the detected photon count at each incremental position;
c. Identifying when the detected photon count equals approximately a
sum of: (a) a baseline noise level, and (b) the expected number of photons calculated for the active area; and
d. Marking this position as the location where an active area of the detector intersects the SPDC cone.

8. The method of claim 1, further comprising:
a. Calculating an efficiency ratio by dividing the actual detected photon count by the expected photon count;
b. Using this efficiency ratio to optimize the alignment of subsequent optical components used in the method; and
c. Maintaining a record of efficiency ratios throughout the optical system to identify potential areas for improvement.

9. The method of claim 1, wherein approximating the number of exiting photons comprises:
a. Multiplying the quantity of entering photons by a conversion efficiency of the nonlinear crystal;
b. Adjusting a time basis of the calculation to match a measurement time of the single photon detector; and
c. Accounting for any known losses between a laser directing the ray of photons and the detector.

10. The method of claim 2, wherein approximating the proportion of the SPDC cone circumference varies based on a position of the active area relative to the cone, such that:
a. For intersections in left or right sections of the cone, a vertical height of the active area is used;
b. For intersections in top or bottom sections, a horizontal width is used; and
c. For intersections in other sections, a diagonal length of the active area is used.

11. A system for implementing the method of claim 1, comprising:
a. An optical energy source configured to produce photons at the first frequency (ω);
b. A nonlinear crystal positioned to receive the photons and generate the SPDC cone;
c. A single photon detector mounted on a precision positioning stage;
d. A measurement system configured to record photon counts over the period of time (t1); and
e. Control electronics configured to compare measured photon counts with calculated expected values.

12. A method of aligning multiple optical components in a quantum optical system using spontaneous parametric down conversion (SPDC), the method comprising:
a. Generating an SPDC cone using a type-1 nonlinear crystal and a pump laser operating at a first frequency (ω);
b. Calculating an expected photon flux at the first frequency (ω) based on a pump laser power rating and Planck's constant;
c. Determining an SPDC conversion efficiency of the nonlinear crystal;
d. Computing an expected SPDC photon flux at a second frequency (ω/2) based on the expected photon flux and the SPDC conversion efficiency;
e. Measuring a baseline noise level using a single photon detector positioned away from an expected SPDC cone path;
f. Implementing noise reduction measures until the baseline noise level is less than the computed expected SPDC photon flux;
g. Sequentially aligning multiple optical components by: (a) Calculating a SPDC cone circumference at each component's position using trigonometric relationships; (b) Estimating expected photon counts within an active area of the detector at each position; (c) Moving the detector perpendicular to an expected photon path until detected counts match expected counts plus baseline noise; (d) Placing each optical component at its corresponding aligned position; and
h. Verifying the alignment by measuring overall system efficiency.

13. The method of claim 12, wherein implementing noise reduction measures comprises:
a. Installing light-blocking enclosures around an experimental area;
b. Adding frequency-specific bandpass filters to the single photon detector;
c. Removing or blocking all non-essential light sources from the experimental area; and
d. Using apertures to block scattered light from the pump laser.

14. The method of claim 12, wherein calculating the SPDC cone circumference comprises:
a. Measuring a physical distance from the nonlinear crystal to each
optical component;
b. Adding the distances between intermediate optical components that redirect the SPDC photons;
c. Using a total path length and a specified SPDC cone angle to calculate a cone radius; and
d. Computing the circumference at each component position.

15. The method of claim 12, further comprising:
a. Maintaining a pump laser power below a specified threshold to prevent damage to the nonlinear crystal;
b. Monitoring a crystal temperature during operation; and
c. Adjusting alignment calculations if thermal effects cause changes in the SPDC cone angle.

16. The method of claim 12, wherein verifying the alignment comprises:
a. Measuring coincidence counts between paired detectors on opposite sides of the SPDC cone;
b. Calculating a ratio of detected coincidence counts to expected coincidence counts; and
c. Optimizing component positions if the measured efficiency falls below a predetermined threshold.

17. A method of aligning an optical component along a spontaneous parametric down conversion (SPDC) cone generated by a nonlinear crystal, the method comprising:
a. Directing a ray of photons from an optical energy source though a nonlinear crystal;
b. Determining an estimate of a quantity of the photons with a first
frequency (ω) entering the nonlinear crystal over a unit of time produced by the optical energy source;
c. Approximating a number of the photons exiting the nonlinear crystal along the cone with a second frequency (ω/2) converted via spontaneous parametric down conversion by the nonlinear crystal over a unit of time;
d. Placing a single photon detector at an estimated location to intercept exiting photons having the second frequency (ω/2);
e. Estimating an expected number of photons to be detected within an active area of the single photon detector during a period of time (t1), comprising:
Approximating that a field of ω/2 photons surrounding the SPDC cone's circumference can be found on a circumference of the SPDC cone;
Assuming the number of the photons exiting the nonlinear crystal along the cone with a second frequency (ω/2) converted via spontaneous parametric down conversion by the nonlinear crystal over a unit of time are evenly distributed over the SPDC cone's circumference to generate a rate of ω/2 photons per unit length;
Approximating a proportion of the SPDC cone circumference that will intersect with the active area of the single photon detector as a geometric chord having the same rate of ω/2 photons per unit length as the SPDC circumference and the same length as the length or width of the active area of the single photon detector;
Multiplying the rate of ω/2 photons per unit length by the length of the geometric chord to produce an expected number of interactions with the active area of the single photon detector per unit of time; and
Multiplying the expected number of interactions with the active area of the single photon detector per unit of time with a quantum efficiency of the single photon detector to produce the expected number of photons to be detected within the active area per unit of time;
f. Measuring an actual quantity of photons detected within the active area during the period of time (t1);
g. If the actual quantity of detected photons is not substantially equal to the expected number of photons, then incrementally moving the single photon detector until the single photon detector detects approximately the expected number of photons within the active area plus a baseline noise level, thereby defining a preferred location for the optical component, and then
h. placing the optical component at that preferred location to receive the photons having the second frequency (ω/2); and
i. Approximating that the field of ω/2 photons surrounding the SPDC cone's circumference can be found on the SPDC cone's circumference;
j. Assuming the number of the photons exiting the nonlinear crystal along the cone with a second frequency (ω/2) converted via spontaneous parametric down conversion by the nonlinear crystal over a unit of time are evenly distributed over the SPDC cone's circumference to generate a rate of ω/2 photons per unit length;
k. Approximating a proportion of the SPDC cone circumference that will intersect with the active area of the single photon detector as a geometric chord having the same rate of ω/2 photons per unit length as the SPDC circumference and the same length as the length or width of the active area of the single photon detector;
l. Multiplying the rate of ω/2 photons per unit length by the length of the geometric chord to produce an expected number of interactions with the active area of the single photon detector per unit of time; and
m. Multiplying the expected number of interactions with the active area of the single photon detector per unit of time with a quantum efficiency of the single photon detector to produce the expected number of photons to be detected within the active area per unit of time.
